(19) United States
(12) Patent Application Publication
(10) Pub. No.: US 2026/0039559 A1
(43) Pub. Date: Feb. 5, 2026

(54) INTELLIGENT CONFIGURATION OF PEER-TO-PEER NETWORK

(71) Applicant: Rilla Limited, Auckland (NZ)

(72) Inventors: Hal SMITH STEVENS, Auckland (NZ); Anupama Pulasthi Bandara APAREKKE JAYASUNDARA MUDIYANSELAGE, Auckland (NZ); Justin TOMLINSON, Waiheke Island (NZ)

(21) Appl. No.: 19/289,797

(22) Filed: Aug. 4, 2025

Related U.S. Application Data
(60) Provisional application No. 63/679,423, filed on Aug. 5, 2024.
(60) Provisional application No. 63/774,997, filed on Mar. 20, 2025.

(51) Int. Cl. H04L 41/12; H04L 41/16; H04L 67/104

(52) U.S. Cl. CPC H04L 41/12; H04L 41/16; H04L 67/104

(57) ABSTRACT

The present disclosure provides a system for optimizing peer-to-peer (P2P) network topology. A reinforcement learning (RL) framework is trained to approximate optimal network topologies and an adaptive peer capacity detection mechanism implemented on peer devices. The RL framework to generate actions for modifying connections between peers based on current network state observations to improve quality of delivery and minimize costs.

### CROSS REFERENCE TO RELATED APPLICATIONS

This application claims priority to U.S. Provisional Application No. 63/679,423, filed on Aug. 5, 2024, and U.S. Provisional Patent Application No. 63/774,997 filed on Mar. 20, 2025, the entire disclosures of which are incorporated herein by reference.

### FIELD OF INVENTION

The present disclosure relates to peer-to-peer network optimization, and more particularly to intelligent orchestration/configuration of peer-to-peer networks using reinforcement learning techniques to improve quality of content delivery.

### BACKGROUND

Cloud service providers predominantly employ hub-and-spoke architectures. In a hub-and-spoke setup, the “hub” acts as a central point of connection, routing all traffic to and from various “spokes.” These spokes can represent individual client networks, virtual private clouds (VPCs), or specific application instances. For large-scale cloud environments, hub-and-spoke architectures often incorporate advanced networking features such as virtual network peering, transit gateways, and VPN connections to facilitate secure and efficient communication between different network segments and external environments. This robust design allows cloud providers to deliver high-performance, secure, and scalable services to a diverse range of clients, from small businesses to large enterprises. However, this adds strain on single/few areas in the underlying internet infrastructure. This concentrated traffic flow leads to significant congestion and bottlenecking at these critical hot-spots within the internet's foundational infrastructure. The result is a detrimental impact on overall network performance, manifesting as increased latency, reduced bandwidth, and a higher likelihood of packet loss for data traversing these congested areas.

This uneven distribution of demand prevents the internet from operating at its full potential, hindering the seamless and rapid data transfer that modern applications and users demand. The architectural implications of such concentrated traffic patterns necessitate robust scaling solutions and intelligent routing protocols to mitigate these issues and ensure a more balanced and efficient use of the global network's vast resources.

Peer-to-peer (P2P) networks have emerged as a decentralized alternative to traditional client-server architectures for distributing content and resources across interconnected computing devices. In P2P systems, individual nodes can act as both clients and servers, allowing for direct communication and resource sharing without relying on a central authority. This distributed approach offers potential benefits in terms of scalability, fault tolerance, and efficient resource utilization.

By allowing individual nodes to directly connect and exchange data, P2P architectures inherently disperse the workload to reduce reliance on central servers and improve overall network resilience. However, while P2P systems excel at decentralization, they present a unique set of challenges when it comes to optimally forming the network topology. The dynamic and often uncoordinated nature of node participation in P2P networks can lead to suboptimal connections, increased latency, and inefficiencies in data routing. For example, Existing P2P systems often face challenges related to network congestion, uneven resource distribution, and suboptimal routing decisions. Additionally, the dynamic nature of P2P networks, where nodes may join or leave the network at any time, further complicates the task of maintaining an efficient and stable network topology.

Current approaches to P2P network optimization typically rely on heuristic-based methods or static optimization algorithms. While these techniques can provide reasonable performance in certain scenarios, they may struggle to adapt to rapidly changing network conditions or scale effectively as the network grows in size and complexity. Furthermore, existing solutions often lack the ability to balance multiple competing objectives, such as maximizing throughput while minimizing energy consumption or network costs.

Another area of concern in P2P networks is the efficient utilization of peer resources, particularly in heterogeneous environments where nodes may have varying capabilities and constraints. Existing systems often struggle to accurately assess and adapt to the changing capacities of individual peers, leading to suboptimal resource allocation and potential network instability.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

As P2P networks continue to evolve and find applications in diverse domains such as content delivery, distributed computing, and decentralized computing (e.g., blockchain) systems, there is a growing need for more sophisticated and adaptive management techniques to obtain optimum performance in P2P networks. The integration of machine learning techniques, particularly reinforcement learning (RL), into P2P network management systems has the potential to address many of these limitations. By leveraging the ability of RL algorithms to learn from experience and adapt to changing environments, it may be possible to develop more robust and efficient P2P networks that can automatically optimize their topology and resource allocation strategies.

However, the application of RL to P2P network optimization is not without technical challenges. The high-dimensional state and action spaces involved in managing large-scale P2P networks can lead to computational complexity and scalability issues. Additionally, the design of appropriate reward functions that accurately capture the desired network behavior and performance metrics remains an open problem.

Disclosed implementations present a novel solution of intelligently orchestrating the topology of the network with ML models trained via reinforcement learning. This allows the cost of optimization to be transferred from network formation time to ML training time. Significantly reducing the cost and time it takes to optimize large networks at scale as compared to conventional heuristic-based approaches which often incur substantial computational and temporal costs.

Disclosed implementations leverage reinforcement learning (RL) paradigms, to front-load these optimization expenses into an offline training phase, thereby minimizing computational overhead during live network operation. This methodology yields several key advantages:
Ameliorated Operational Expenditures: Offline training shifts computational intensity away from live deployments, substantially reducing ongoing operational costs.
Accelerated Optimization Cycles: Pre-trained RL models enable near real-time determination of optimal network topologies and configurations.
Enhanced Scalability: RL's inherent ability to learn complex, non-linear mappings allows for efficient optimization across large-scale, intricate network architectures.
Dynamic Adaptive Orchestration: Models are engineered to intelligently reconfigure network topology in response to fluctuating operational parameters and environmental conditions.
Anticipatory Anomaly Mitigation: The predictive capabilities of trained models facilitate the proactive identification and mitigation of potential network performance degradations or failures.

The disclosed implementations represent a fundamental paradigm shift in network management, enabling infrastructures to autonomously learn, adapt, and self-organize at an unprecedented scale and velocity, culminating in the deployment of highly efficient, resilient, and economically viable network systems.

According to an aspect of the present disclosure, an orchestrator system for optimizing peer-to-peer (P2P) network topology is provided to continuously optimize the P2P network topology. The orchestrator system includes a reinforcement learning (RL) framework trained to approximate optimal network topologies. The system further includes an adaptive peer capacity detection mechanism implemented, at least in part, on peer devices. The orchestrator system is configured to use the RL framework to generate actions for modifying connections between peers based on current network state observations to improve quality of delivery and minimize costs.

According to another aspect of the present disclosure, a method for optimizing peer-to-peer (P2P) network topology is provided. The method includes receiving current state information of a P2P network. The method also includes inputting the current state information into a trained reinforcement learning (RL) model. The method further includes generating, by the RL model, actions for modifying connections between peers in the P2P network. The method additionally includes applying the generated actions to the P2P network to optimize the network topology for improved quality of delivery and minimized costs.

According to another aspect of the present disclosure, a non-transitory computer-readable medium storing instructions is provided. When executed by one or more processors, the instructions cause the one or more processors to perform operations for adaptive peer capacity detection in a peer-to-peer (P2P) network. The operations include receiving, by a centralized orchestrator, current state information of a P2P network. The method also includes inputting the current state information into a trained reinforcement learning (RL) model. The method further includes generating, by the RL model, actions for modifying connections between peers in the P2P network. The method additionally includes applying the generated actions to the P2P network to optimize the network topology for improved quality of delivery and minimized costs.

The system, method, and non-transitory computer-readable medium may include one or more of the following features. The RL framework may comprise a graph neural network (GNN) trained to process network topology information. The GNN may be configured to generate flow rate estimates and link bandwidth utilization predictions based on the current network state observations. The adaptive peer capacity detection mechanism may comprise a peer-capacity-ratio (PCR) heuristic for dynamically allocating capacity for P2P traffic while maintaining reliable connections. The PCR heuristics may be configured to incrementally increase capacity allocation upon successful data delivery and aggressively reduce capacity allocation upon detection of packet loss. The PCR heuristic may be further configured to adjust the PCR across all consumers connected to a producer when a new consumer is added. The centralized orchestrator may be further configured to remove peer connections based on the adjusted PCR and network performance metrics.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of an orchestrator system architecture for optimizing peer-to-peer network connections, according to aspects of the present disclosure.

FIG. 2 illustrates a sequence diagram depicting interactions between a Producer, Consumers, and an Orchestrator in a peer-to-peer network, according to aspects of the present disclosure.

FIG. 3 depicts a graph showing Average Peer Capacity Ratio over time in a peer-to-peer network, according to aspects of the present disclosure.

### DETAILED DESCRIPTION

The following description sets forth exemplary aspects of the present disclosure. It should be recognized, however, that this description is not intended as a limitation on the scope of the present disclosure. Rather, the description also encompasses combinations and modifications to those exemplary aspects described herein.

Recent advancements in machine learning and artificial intelligence have opened new possibilities for optimizing P2P network topologies and improving overall system performance. Reinforcement learning (RL) techniques, in particular, have shown promise in addressing complex decision-making problems in dynamic environments. The application of RL to P2P network optimization presents opportunities for adaptive and self-improving systems that can respond to changing network conditions and user demands.

To optimize P2P networks at scale in real-time, it is necessary to accurately approximate the optimal topology as peers join, leave and change state with sub-second latency. Traditional methods like search algorithms or linear solvers are too slow and heuristic based methods cannot approximate the problem well enough as it need to be manually modeled. Although supervised machine learning presents a viable potential approach to address the limitations of the prior art, comprehensive datasets encompassing all potential dynamic network conditions (which are required to train supervised machine learning architectures) are currently unavailable.

The disclosed techniques improve quality of delivery and minimize costs in P2P networks through intelligent orchestration and adaptive capacity detection. In some cases, an orchestrator may continuously optimize the P2P network topology. The centralized orchestrator may include a reinforcement learning (RL) framework trained to approximate optimal network topologies. Based on current network state observations, the RL framework may generate actions for modifying connections between peers. The orchestrator may apply these actions to adjust the network topology.

An adaptive peer capacity detection mechanism may be implemented, at least in part, on peer devices participating in the P2P network. This mechanism may enable dynamic allocation of capacity for P2P traffic while maintaining reliable connections. By combining centralized optimization with distributed adaptive techniques, the disclosed systems and methods may achieve improved performance and efficiency in P2P networks. The reinforcement learning approach may allow the system to learn effective optimization strategies through experience. Meanwhile, the adaptive mechanisms may enable fine-grained adjustments based on local conditions.

The system may be organized into various software “modules” to facilitate clarity of description. A software module is a unit of code stored in memory and/or executed on a processor that performs a specific function within a larger software system. While the modules described herein are segregated by function, the code of each module need not be stored in a contiguous manner or on the same device.

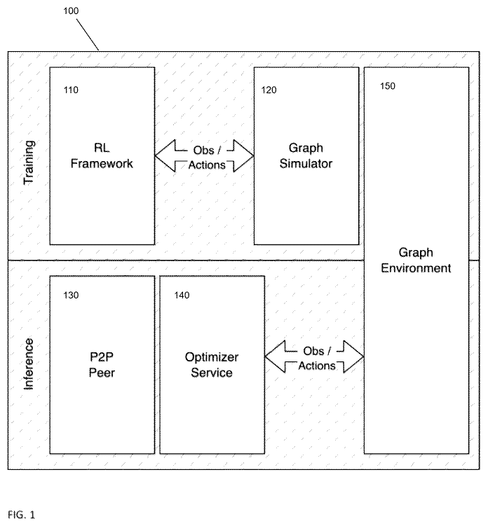

FIG. 1 illustrates a block diagram of an orchestrator system architecture in accordance with disclosed implementations. The system 100 may include a training portion and an inference portion that each interact with a graph environment module 150. The training portion of system 100 may comprise a reinforcement learning (RL) framework module 110 that communicates with a graph simulator module 120 through observations and actions. The RL framework module 110 may process observations from the graph simulator module 120 and determine appropriate actions to optimize the network topology. The graph simulator module 120 is the mechanism that drives external factors in the environment that the agent is not directly influencing. ex: Introducing new nodes and latency, and random disconnections. In some implementations, the RL framework module 110 may comprise a graph neural network (GNN) trained to process network topology information. The GNN may be configured to generate flow rate estimates and link bandwidth utilization predictions based on the current network state observations.

The RL framework module 110 may use a reward function that considers multiple factors when optimizing the network topology. These factors may include latency, packet loss, bandwidth utilization, congestion, infrastructure costs, network resilience, and load balancing. By incorporating these diverse metrics, the RL framework module 110 may learn to make decisions that balance various aspects of network performance and cost. To facilitate training, the RL framework module 110 may utilize a ‘gym’ environment to simulate real-world internet infrastructure scenarios. This approach may allow the RL framework module 110 to learn transition probabilities through interaction with the simulated environment, enabling it to develop effective strategies for network optimization without requiring extensive real-world data. For example, OpenAI Gym, a toolkit designed for developing and comparing RL algorithms, can be used.

The inference portion of system 100 may include a P2P peer module 130 and an optimizer service module 140 that interface with the graph environment module 150. The P2P peer module 130 may store and/or access a data structure representing current nodes in the peer-to-peer network, while the optimizer service module 140 may manage and optimize the network connections between the nodes of the network. In some cases, the P2P peer module 130 may implement an adaptive peer capacity detection mechanism. This mechanism is described in greater detail below and may enable the P2P peer module 130 to dynamically adjust its capacity allocation based on network conditions and performance metrics.

The graph environment module 150 may provide the operational context for both training and inference operations. The graph environment module 150 stores one or more data structures representing the universe that the agent observes and interacts with. During training, the graph environment module 150 may enable the RL framework module 110 to learn optimal policies through simulated scenarios. During inference, the graph environment module 150 may represent the actual peer-to-peer network environment where the learned policies are applied.

By combining these components, the system 100 may enable continuous optimization of the P2P network topology by applying reinforcement learning techniques. The observations and actions flow between components to provide dynamic adjustment of network connections based on current conditions and learned optimization strategies.

The RL framework module 110 trains RL agents that may process observations from the graph simulator module 120, which may represent simulated network states and conditions. Based on these observations, the RL agents in the framework module 110 may determine appropriate actions to optimize the simulated network topology. The graph simulator module 120 thus provided a simulated environment for training the RL framework module 110. This simulated environment may allow the RL framework module 110 to learn effective optimization strategies without requiring extensive real-world data.

The RL Framework module may be implemented using various technical approaches. Here are some examples of potential architectures, algorithms, training methods, and protocols that could be used:
Architectures: 1. Deep Q-Network (DQN): May utilize a neural network to approximate the Q-function, mapping state-action pairs to expected rewards. 2. Policy Gradient Methods: Could implement algorithms like REINFORCE or Proximal Policy Optimization (PPO) to directly learn a policy function. 3. Actor-Critic Models: May combine value function approximation and policy optimization, potentially using architectures like Advantage Actor-Critic (A2C) or Soft Actor-Critic (SAC). 4. Graph Neural Networks (GNNs): Could be employed to process and learn from graph-structured network topology data, using variants like Graph Convolutional Networks (GCN) or Graph Attention Networks (GAT).
Algorithms: 1. Q-Learning: May be used as a foundation for value-based methods, especially in discrete action spaces. 2. SARSA (State-Action-Reward-State-Action): Could be implemented for on-policy learning scenarios. 3. Trust Region Policy Optimization (TRPO): May be used to ensure stable policy updates during training. 4. Distributed Reinforcement Learning: Could implement algorithms like Ape-X or IMPALA for parallel training across multiple agents. 5. Multi-Agent Reinforcement Learning (MARL): May be used to model interactions between multiple peers in the network.
Training Methods: 1. Experience Replay: Could store and randomly sample past experiences to break correlations between consecutive training samples. 2. Prioritized Experience Replay: May prioritize important transitions to replay, potentially improving learning efficiency. 3. Curriculum Learning: Could structure the learning process by gradually increasing the complexity of training scenarios. 4. Transfer Learning: May leverage pre-trained models on simpler network topologies to accelerate learning on more complex scenarios. 5. Meta-Learning: Could implement algorithms like Model-Agnostic Meta-Learning (MAML) to enable quick adaptation to new network conditions.
Protocols: 1. Epsilon-Greedy Exploration: May balance exploration and exploitation during training by occasionally taking random actions. 2. Boltzmann Exploration: Could use a softmax distribution over action values to guide exploration. 3. Parameter Noise: May add adaptive noise to the parameters of the neural network to encourage exploration. 4. Hindsight Experience Replay (HER): Could be used to learn from failed attempts by retroactively changing the goal of an episode. 5. Intrinsic Motivation: May implement curiosity-driven or novelty-seeking behaviors to encourage exploration of the state space. The RL Framework module may integrate these components based on the specific requirements of the P2P network optimization task. It may also incorporate techniques for handling partial observability, dealing with large discrete or continuous action spaces, and managing the trade-off between sample efficiency and computational complexity.

The graph simulator module 120 plays a crucial role in the training process of the RL framework module 110 by providing a controlled and reproducible environment that mimics real-world P2P network scenarios. This simulated environment incorporates various network conditions, topologies, and dynamic events that the RL framework might encounter in actual deployments. By leveraging this simulator, the system can generate a vast array of training scenarios, including edge cases and rare events that might be difficult or costly to reproduce in real-world networks.

The simulated environment allows for rapid iteration and experimentation with different RL algorithms, reward functions, and network configurations. This accelerates the learning process and enables the RL framework to explore a wide range of optimization strategies without the risks and limitations associated with testing on live networks. The simulator can be configured to represent different scales of networks, from small clusters to large-scale distributed systems, allowing the RL framework to develop strategies that are effective across various network sizes and complexities.

Furthermore, the use of a simulated environment addresses the challenge of data scarcity in P2P network optimization. Real-world P2P networks often have limited observability and may not provide comprehensive data on all aspects of network performance. The simulator can generate synthetic data that covers a broad spectrum of network states and behaviors, ensuring that the RL framework is exposed to a diverse set of scenarios during training. This comprehensive training data helps the RL framework develop robust and generalizable optimization strategies that can be effectively applied to real-world P2P networks.

The simulator for P2P network optimization may be implemented using various technical approaches. Here are some examples of potential architectures, algorithms, and data structures that could be used:
Architecture: The simulator may utilize a modular architecture with components such as: 1. Network Topology Generator: Creates realistic P2P network structures using graph generation algorithms like Barabási-Albert or Watts-Strogatz models. 2. Traffic Generator: Simulates realistic data flows between peers using statistical models or trace-based replay. 3. Node Behavior Module: Implements peer join/leave events and capacity fluctuations. 4. Link Characteristics Module: Simulates network conditions like latency, packet loss, and bandwidth constraints. 5. Event Scheduler: Manages the timing and execution of network events. 6. Metrics Collector: Gathers performance data on throughput, latency, resource utilization, etc. 7. Visualization Engine: Provides graphical representation of network state and metrics.
Algorithms: 1. Discrete Event Simulation (DES): May be used as the core simulation algorithm to model the P2P network as a series of discrete events. 2. Flow-level Network Simulation: Could be employed to simulate data transfers between peers without the overhead of packet-level simulation. 3. Monte Carlo Methods: May be used to introduce randomness and generate diverse network scenarios. 4. Gossip Protocols: Could be implemented to simulate peer discovery and information dissemination in the P2P network. 5. Adaptive Bitrate Algorithms: May be used to simulate dynamic content delivery in video streaming scenarios.
Data Structures: 1. Graph Representations: Adjacency lists or matrices to represent the P2P network topology. 2. Priority Queues: May be used in the event scheduler to manage upcoming network events. 3. Circular Buffers: Could be employed to simulate peer upload/download queues. 4. Bloom Filters: May be used to efficiently represent content availability across the network. 5. Distributed Hash Tables (DHTs): Could be implemented to simulate content indexing and lookup in the P2P network. 6. Time Series Data Structures may be used to store and analyze historical performance metrics. The simulator may integrate these components using a modular software design, allowing for easy extension and customization. It may also incorporate parallel processing techniques to handle large-scale network simulations efficiently. The specific implementation details would depend on the particular requirements of the P2P optimization problem being addressed.

The P2P peer module 130 stores a dynamic representation of individual nodes in the peer-to-peer network that is being optimized by the system. The P2P peer module 130 may implement adaptive peer capacity detection mechanisms (an example of which is described below) which may enable dynamic allocation of capacity for P2P traffic. The P2P peer module may be implemented using various technical approaches. Various architectures can be applied to create the P2P peer module 130. These architectures can include:
1. A Distributed Hash Table (DHT) (a decentralized system that provides a lookup service similar to a traditional hash table) such as Chord, Kademlia, or Pastry for efficient content lookup and routing.
2. Gossip-based (or epidemic protocol) which spreads information across a network of nodes.
3. A combination of centralized elements with distributed peer interactions, potentially using super-peers for improved scalability.
4. A distributed ledger for maintaining network state and transaction history.

Various algorithms can be applied by the P2P peer module 130, including:
1. Peer Discovery may be accomplished by applying random walks, expanding ring searches, or bootstrap servers to find and connect to other peers.
2. Content Routing can be determined by prefix routing, XOR metric, or other distance-based algorithms for efficient content location.
3. Load Balancing can be accomplished by applying consistent hashing or virtual server techniques to distribute content and requests evenly across peers.
4. Network Coding can employ linear network coding or fountain codes for efficient data dissemination and error correction.
5. Adaptive Bitrate Streaming can be accomplished using subgraphs that caters for sub-renditions of a stream dynamic quality adjustment in video streaming scenarios.

Data structures utilized by the P2P peer module 130 can include:
1. Routing Tables can use k-buckets, finger tables, or prefix trees to store peer contact information and optimize routing decisions.
2. A Content Index can be implemented using inverted indexes or bloom filters for efficient content discovery and lookup.
3. A Peer List can use dynamic arrays or linked lists to maintain connections to active peers.
4. LRU (Least Recently Used) or LFU (Least Frequently Used) caches can be used to store frequently accessed content.
5. Merkle Trees can be used for efficient verification of large datasets across the network.

The P2P peer module 130 may integrate these components based on the specific requirements of the P2P network application. The P2P Peer module can also incorporate mechanisms for handling churn (peers joining and leaving), ensuring data integrity, and managing peer reputation or incentive systems.

An optimizer service module 140 is configured to manage and optimize network connections based on the learned strategies from the RL framework module 110. The optimizer service module 140 may receive notifications from the P2P peer module 130 regarding changes in peer capacity ratio (PCR), or other network changes. These notifications may allow the optimizer service module 140 to make informed decisions about peer assignments and network topology optimization.

The optimizer service module 140 may employ various techniques to manage and optimize network connections. For example, the module may utilize a hybrid approach combining both TCP and UDP protocols. For TCP connections, it may implement a modified slow-start algorithm to quickly ramp up connection speeds while avoiding network congestion. UDP may be used for time-sensitive data transfers, with the module implementing its own reliability layer on top of UDP for critical packets. For load balancing, the optimizer service may employ a weighted round-robin algorithm that takes into account both peer capacity ratios (PCR) and current network conditions. It may dynamically adjust weights based on real-time performance metrics, allowing it to distribute load efficiently across available peers.

The optimizer service module 140 may implement a heartbeat mechanism to continuously monitor peer availability. Upon detecting a peer failure, it may initiate a fast reroute procedure, redirecting traffic to pre-computed backup paths. This may be complemented by a distributed consensus algorithm to ensure all nodes have a consistent view of the network topology. The optimizer service module 140 may utilize adaptive bitrate streaming techniques, dynamically adjusting video quality based on available bandwidth. It may also implement network coding schemes, such as fountain codes, to improve throughput in lossy network conditions.

The optimizer service module 140 may employ end-to-end encryption for all peer connections using the TLS 1.3 protocol. It may also implement a challenge-response authentication mechanism to verify peer identities and prevent unauthorized access to the network. The optimizer service may maintain a time-series database to track connection metrics over time. It may use anomaly detection algorithms to identify potential issues and implement a distributed tracing system to debug complex multi-peer interactions. The optimizer service module 140 can be configured to utilize output of the RL Framework module 110 to predict network congestion and proactively adjust connection parameters.

The graph environment module 150 may provide the operational context for both training and inference operations. During training, the graph environment module 150 may enable the RL framework module 110 to learn optimal policies through simulated scenarios. During inference, the graph environment module 150 may represent the actual peer-to-peer network environment where the learned policies are applied.

The graph environment module 150 can represent the P2P network topology using an adjacency list structure, allowing for efficient storage and traversal of large-scale networks. Each node in the graph may be associated with a feature vector storing relevant attributes such as bandwidth capacity, processing power, and current load. Edge information may be stored using weighted connections, with weights representing metrics like latency or link quality.

Graph traversal algorithms such as breadth-first search or depth-first search may be employed to efficiently explore the network topology. The module may implement graph partitioning algorithms to divide large networks into manageable subgraphs for parallel processing. Shortest path algorithms like Dijkstra's or A may be used to compute optimal routes between peers.

The graph environment module 150 may expose an API that allows the RL framework module 110 to query network state and allow optimizer service module 140 to apply actions. It may implement an observer pattern to notify the optimizer service module 140 of significant topology changes. The graph environment module 150 may also provide interfaces for the P2P peer module 130 to update local state information.

During training of RL framework module 110, the graph environment module 150 may generate synthetic network scenarios by applying stochastic processes to modify graph structure and node attributes. For inference graph network module 150 may provide real-time snapshots of the network state, including current topology, traffic patterns, and performance metrics. The module may maintain historical context through a time-windowed graph representation, allowing for temporal analysis of network evolution. The graph environment module 150 may employ efficient indexing structures like R-trees or quad-trees to enable fast spatial queries on the network topology. It may implement caching mechanisms to store frequently accessed subgraphs or computation results, improving response times for repeated queries and may utilize graph compression techniques to reduce memory footprint while preserving important structural information.

The interactions between these modules enables the system 100 to continuously adapt and optimize the P2P network topology. By combining centralized optimization strategies with distributed adaptive mechanisms, the system 100 may achieve improved performance and efficiency in P2P networks.

As noted above, the system 100 may implement an adaptive peer capacity detection mechanism to dynamically allocate capacity for peer-to-peer (P2P) traffic while maintaining reliable connections. This mechanism may utilize a peer-capacity-ratio (PCR) heuristic inspired by TCP flow control protocols.

The adaptive peer capacity detection allows peers to dynamically allocate capacity towards the P2P protocol while maintaining reliable connections both upstream and downstream. With end-user devices and internet connections, adding or removing a peer could have significant impact both on other P2P connections and general activity of the other user applications. This is exacerbated by asymmetric network capacity on upstream and downstream, where contention in one direction could negatively affect the other, potentially impacting the connection to the origin CDN that downloads source content at the root level. On the other hand, capacity measurement by sending data that is not useful to a consumer is wasteful and could amount to a significant portion of the network traffic if peer-churn is high.

The adaptive peer-capacity detection gauges upstream capacity of a producer by allowing consumers to connect optimistically, and using a heuristic called peer-capacity-ratio (PCR) to only send a part of a media segment to connected consumers. The peer-capacity-ratio is the ratio of a peer's upload capacity to its download capacity. This ratio is crucial for understanding and optimizing the performance and efficiency of P2P networks. The content consumers would defer to the origin for the rest of the segment, or the full segment if the producer fails to deliver data within the segment deadline. This provides a safe fallback to consumers if the producer is unable to deliver.

Upon successful delivery, the content producer will increment the PCR to deliver more of a segment until stability is achieved. When a new consumer is added, the producer will adjust the PCR across all consumers and restart the process. If packet loss is detected, the PCR is aggressively reduced to prevent saturation of the producer's upload bandwidth. This methodology is analogous to TCP's additive increase, multiplicative decrease flow control scheme. The PCR-based approach enables the network to optimistically continue allocating additional consumers, while simultaneously allowing the producer to manage its upload utilization.

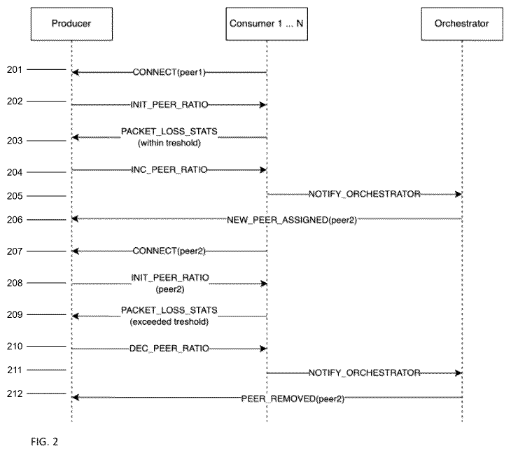

FIG. 2 illustrates a sequence diagram depicting a peer ratio adjustment process between a content producer, one or more content consumers, and an “Orchestrator” (an example of system 100) in the adaptive peer capacity detection process. The sequence begins at 201 with a CONNECT message from the Producer to the Consumer, establishing a peer1 connection. Following this, an INIT_PEER_RATIO message is exchanged between the Consumer and Producer at 202. The Producer then sends PACKET_LOSS_STATS to the Consumer, at 203, indicating these statistics are within threshold parameters. At 204, the Consumer responds with an INC_PEER_RATIO message to the Producer. At this point, the Consumer sends a NOTIFY_ORCHESTRATOR message to the Orchestrator at 205. The Orchestrator then initiates a NEW_PEER_ASSIGNED message for peer2, which is sent to the Producer at 206. This triggers a new CONNECT message from the Producer to the Consumer for peer2, at 207, followed by another INIT_PEER_RATIO message specifically for peer2 at 208. Subsequently, the Producer sends PACKET_LOSS_STATS that exceed the threshold, at 209, prompting the Consumer to respond with a DEC_PEER_RATIO message at 210 The Consumer then sends another NOTIFY_ORCHESTRATOR message to the Orchestrator at 211. The sequence concludes with a PEER_REMOVED message for peer2, which is sent from the Orchestrator to the Producer, at 212 effectively terminating that specific peer connection. The diagram effectively demonstrates the dynamic nature of peer ratio adjustments and the orchestrator's role in managing peer assignments based on network performance metrics.

The adaptive peer capacity detection mechanism allows consumers to connect optimistically to a producer. Upon connection, the P\producer may use the PCR to determine the portion of a media segment to send to connected consumers. Consumers may defer to an origin content delivery network (CDN) for the remainder of the segment, or for the full segment if the producer fails to deliver data within a specified segment deadline. This approach may provide a safe fallback for consumers if the producer is unable to deliver content effectively.

In some cases, the system 100 may monitor packet loss statistics for data transmitted from the producer to the consumer. Based on these statistics, the PCR may be dynamically adjusted to optimize data delivery while maintaining network stability.

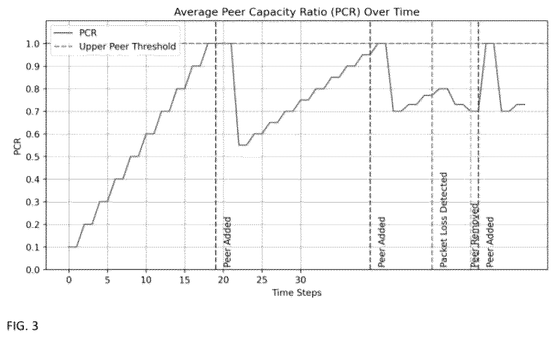

FIG. 3 depicts a graph showing the Average Peer Capacity Ratio over time in an example network, illustrating the dynamic nature of PCR adjustments in response to network events. The PCR heuristic may be configured to incrementally increase capacity allocation upon successful data delivery. This gradual increase is visible in the graph as the PCR line rises steadily between events.

Conversely, the PCR heuristic may be configured to aggressively reduce capacity allocation upon detection of packet loss exceeding a predetermined threshold. This behavior is evident in FIG. 3 where the PCR drops sharply following the “Packet Loss Detected” event, demonstrating the system's rapid response to potential network congestion.

When a new Consumer is added to the network, the PCR may be adjusted across all Consumers connected to the Producer. This adjustment process is illustrated in FIG. 3 by the vertical dashed lines labeled “Peer Added,” each followed by a significant drop in PCR before it begins to increase again.

The adaptive peer capacity detection mechanism may redistribute available bandwidth among the connected Consumers based on their individual data requirements and network conditions. This dynamic allocation may help maintain optimal network performance as peers join and leave the network. By employing this adaptive peer capacity detection mechanism, the system 100 may effectively manage network resources, ensure reliable connections, and optimize data delivery in dynamic P2P network environments.

A reinforcement learning agent, in the context of optimizing network topology, can undergo a Markov Decision Process (MDP) characterized by the following elements:
States(S): The state of the environment at any given time. This includes:
   Current Network Topology: The existing connections and structure of the P2P network (e.g., adjacency matrix, graph representation).
   Node Characteristics: Information about each peer in the network, such as:
      Bandwidth capacity
      Processing power
      Latency to other nodes
      Geographical location
      Uptime/availability
      Trust score/reputation
   Traffic Patterns and Load: Current and predicted data flow, congestion levels, and overall network demand.
   External Environmental Conditions: Broader internet infrastructure conditions, ISP routing policies, and any real-time measurements from the network.
Actions (A): The decisions the RL agent can make to modify the network topology. These actions aim to establish, modify, or remove connections between peers to optimize performance. Examples include:
   Establishing a Connection: Deciding to form a direct connection between two specific peers.
   Breaking a Connection: Deciding to terminate an existing connection between two peers.
   Modifying Connection Parameters: Adjusting bandwidth allocation or priority for an existing link.
   Suggesting New Node Roles: Assigning a peer as a super-node or a specific type of relay.
   Routing Decisions: Influencing data paths within the network (though this can also be an outcome of topology).
Transition Probability (P): The probability of moving from one state to another given a specific action. While the environment is dynamic (peers joining/leaving), the agent aims to learn the consequences of its actions. For instance, connecting two peers with high latency might increase overall network latency, whereas connecting two proximate peers might reduce it. This is often not explicitly known but learned through interaction. In the “gym” simulation environment, these probabilities are defined by the simulator's rules for how the network evolves.
Reward Function (R): This is the most crucial element, defining what constitutes an “optimal” network topology. The agent receives a reward signal after taking an action, indicating how good or bad that action was for the overall objective. The reward function is designed to guide the agent towards minimizing costs and improving quality of delivery. Examples of reward components include:
   Negative Reward for Latency: Penalizing increased communication delay between peers.
   Negative Reward for Packet Loss: Penalizing data loss.
   Positive Reward for Bandwidth Utilization: Rewarding efficient use of available network capacity.
   Negative Reward for Congestion: Penalizing bottlenecks at specific nodes or links.
   Negative Reward for Infrastructure Costs: Penalizing connections that incur higher operational expenses.
   Positive Reward for Network Resilience: Rewarding topologies that are resistant to single points of failure.
   Positive Reward for Load Balancing: Rewarding even distribution of traffic.
Policy (π): This is the agent's strategy, mapping observed states to actions. The goal of reinforcement learning is to learn an optimal policy that maximizes the cumulative reward over time. This policy dictates how the RL agent decides to connect, disconnect, or reconfigure peers based on the current network state to achieve the desired performance metrics.

By continuously interacting with the simulated network environment, taking actions, observing the resulting state changes, and receiving rewards, the RL agent learns which actions lead to desirable outcomes (high rewards) and which lead to undesirable ones (low or negative rewards). This iterative process allows the agent to refine its policy until it can effectively orchestrate the P2P network topology to improve quality of delivery and minimize costs in real-time.

This patent introduces a novel approach to optimizing P2P networks, aiming to improve delivery quality and reduce costs. It addresses the inherent inefficiencies of traditional hub-and-spoke cloud architectures, which centralize traffic and create bottlenecks, as well as the challenges of decentralized P2P systems, such as dynamic node participation, lack of central control, and network fragmentation. The core problem lies in forming optimal P2P topologies, a complex, NP-Hard challenge.

The proposed solution involves a centralized orchestrator that continuously optimizes the P2P network topology. This optimization is driven by machine learning (ML) models trained through reinforcement learning (RL), coupled with an SDK on peer devices for adaptive data delivery. This shifts the computational cost of optimization from network formation to ML training time, significantly reducing the overall time and expense for large networks. Key advantages of this ML-driven solution include reduced operational expenditures, accelerated optimization cycles, enhanced scalability, dynamic adaptive orchestration, and anticipatory anomaly mitigation.

A central innovation is the use of RL-based ML agents to solve large-scale graph optimization problems in real-time. This is achieved by simulating real-world internet infrastructure scenarios in a “gym” environment, allowing RL agents to learn optimal policies without extensive pre-existing datasets. The Reinforcement Learning Agent operates as a Markov Decision Process, with states encompassing network topology, node characteristics, traffic patterns, and environmental conditions. Its actions involve establishing, breaking, or modifying connections and influencing routing. The agent learns transition probabilities and is guided by a reward function that incentivizes low latency, minimal packet loss, high bandwidth utilization, network resilience, and load balancing, while penalizing congestion and infrastructure costs. The agent's policy, learned to maximize cumulative reward, enables continuous refinement for real-time P2P network topology orchestration.

The implementation of this real-time optimization achieved up to a 90% load deflection from centralized infrastructure. This decentralization was accomplished while maintaining minimum latency, quality, and reliability, ultimately leading to high quality of delivery and minimized costs. The adaptive peer capacity mechanism allows peers to dynamically allocate capacity for P2P traffic while maintaining reliable connections, addressing issues like asymmetric network capacity and wasteful data transmission. It functions by allowing consumers to optimistically connect, with producers sending only a portion of a media segment based on a Peer-Capacity-Ratio (PCR). If the producer fails, consumers fall back to the origin for the remainder of the segment. The PCR adjusts dynamically, incrementing on successful delivery and aggressively reducing upon packet loss, similar to TCP's additive increase, multiplicative decrease, enabling efficient scaling of consumers while producers manage upload utilization.

In summary, the combination of reinforcement learning for global topology optimization and adaptive peer capacity detection for local adjustments provides a comprehensive solution to P2P network optimization challenges. This approach may offer improved adaptability, efficiency, and scalability compared to existing methods, enabling more effective management of complex and dynamic P2P network environments. The reinforcement learning of the disclosed implementations results in more effective and dynamic optimization of P2P network topologies compared to traditional heuristic-based methods. By learning through interaction with simulated network environments, the reinforcement learning framework can develop sophisticated policies for network optimization that adapt to complex and changing conditions. This approach overcomes limitations of manually designed heuristics, which may struggle to account for the multifaceted nature of P2P network dynamics.

The reinforcement learning framework can process high-dimensional network state information, including topology, node characteristics, and traffic patterns. This comprehensive view allows for more nuanced decision-making compared to approaches that rely on a limited set of predefined metrics. The framework can learn to balance multiple competing objectives, such as minimizing latency, maximizing bandwidth utilization, and ensuring network resilience, in ways that may be difficult to achieve through traditional optimization techniques.

By shifting the computational burden of optimization to an offline training phase, the reinforcement learning approach enables near real-time topology adjustments in live P2P networks. This represents a significant improvement over iterative optimization methods that struggle to keep pace with rapidly changing network conditions. The trained model can quickly generate actions for modifying peer connections based on current observations, allowing for responsive adaptation to network events.

The adaptive peer capacity detection mechanism can address challenges related to heterogeneous peer capabilities and dynamic network conditions in P2P systems. By employing a peer-capacity-ratio (PCR) heuristic, the system can dynamically allocate capacity for P2P traffic while maintaining reliable connections. This approach overcomes limitations of static capacity allocation methods, which may fail to account for changing peer capabilities and network congestion.

The PCR heuristic allows for fine-grained adjustment of peer contributions based on observed performance. By incrementally increasing capacity allocation upon successful data delivery and aggressively reducing allocation upon packet loss detection, the system may achieve a balance between maximizing peer utilization and maintaining network stability. This adaptive approach is more robust to changing network conditions compared to fixed threshold-based methods.

The combination of centralized reinforcement learning-based optimization with distributed adaptive peer capacity detection enables a multi-layered approach to P2P network optimization. This hybrid strategy leverages global network knowledge for high-level topology decisions while allowing individual peers to make local adjustments based on immediate conditions. This synergy results in more efficient and resilient P2P networks compared to purely centralized or purely distributed optimization approaches.

By enabling peers to connect optimistically and adjusting capacity allocation dynamically, the system achieves improved resource utilization compared to conservative connection strategies. The ability to redistribute available bandwidth among connected peers based on individual data requirements and network conditions may lead to more efficient use of network resources and improved quality of service for P2P applications. The phrase “connect optimistically” means that consumers can initially establish connections to a producer without first confirming the producer's full capacity or ability to deliver content. This approach allows for rapid connection between peers. The system then uses the peer-capacity-ratio (PCR) to dynamically manage these connections based on actual performance. If the producer cannot deliver data effectively, the consumer can fall back to an origin content delivery network (CDN) for the remainder of the content. This optimistic connection strategy enables faster initial connections, immediate data transfer attempts, and the gathering of real-world performance data to further optimize the network. It provides a balance between quick connection establishment and ensuring reliable content delivery, allowing the system to adapt rapidly to changing network conditions while maintaining service quality.

The disclosed techniques also address scalability challenges in P2P network optimization. The use of graph neural networks within the reinforcement learning framework enables efficient processing of large-scale network topologies. This approach overcomes limitations of optimization methods that struggle with the computational complexity of large P2P networks.

Various file transmission protocols can be used in accordance with the disclosed implementations such as BitTorrent Protocol, IPFS (InterPlanetary File System). The implementation can use content-addressed storage and distributed naming for decentralized content distribution. Browser-based peer-to-peer communication can be leveraged for direct data exchange between peers.

The disclosed implementations can be accomplished through various software modules, i.e., software code stored and/or executing on hardware to provide a specified function. The modules need not be discrete code and can be stored and executed on various computing devices.

A number of implementations have been described. Nevertheless, it will be understood that various modifications may be made without departing from the spirit and scope of the disclosure. Accordingly, other implementations are within the scope of the following claims.

What is claimed:

1. A system for optimizing a peer-to-peer (P2P) network topology, comprising:
a reinforcement learning (RL) framework including a graph neural network (GNN) trained to process network topology information and approximate optimal network topologies;
an adaptive peer capacity detection mechanism; and
an optimizer service configured to use an output of the RL framework to generate actions for modifying connections between peers based on current network state observations applying the actions to the P2P network to optimize the network topology.

2. The system of claim 1, wherein the GNN is configured to generate flow rate estimates and link bandwidth utilization predictions based on the network topology information.

3. The system of claim 1, wherein the adaptive peer capacity detection mechanism includes a peer-capacity-ratio (PCR) heuristic for dynamically allocating capacity for P2P traffic while maintaining reliable connections.

4. The system of claim 3, wherein the PCR heuristic is configured to:
incrementally increase capacity allocation upon successful data delivery; and
aggressively reduce capacity allocation upon detection of packet loss.

5. The system of claim 4, wherein the PCR heuristic is further configured to:
adjust the PCR across all consumers connected to a producer when a new consumer is added.

6. The system of claim 5, wherein the optimizer service is configured to remove peer connections based on the adjusted PCR and network performance metrics.

7. The system of claim 5, further comprising a graph simulator configured to drive external factors in the network topology.

8. The method of claim 1, further comprising a graph environment module storing one or more data structures representing the of the network topology.

9. A method for optimizing a peer-to-peer (P2P) network topology, the method comprising:
establishing a peer connection between a producer and a consumer;
exchanging a peer ratio message is exchanged between the consumer and producer;
the producer sending packet loss information to the consumer;
the consumer sending an incremental peer ratio message to the producer indicating how the peer ratio changes over time or with additional peers;
the consumer sending a notify message to an orchestrator;
in response to the notify message, the orchestrator initiating a new peer assigned message to the producer;
in response to the new peer assigned message, sending connect message from the producer to the consumer for the new peer followed by another peer ratio message for the new peer;
the producer sending to the consumer a packet loss information that indicates a packet loss threshold has been exceeded;
the consumer sending a decrease peer ratio message indicating a decrease in the peer ratio a notify orchestrator message to an orchestrator; and
the orchestrator sending a peer removed message for the new peer to the producer to terminate the connection with the new peer.

10. The method of claim 9, wherein the orchestrator comprises:
a reinforcement learning (RL) framework including a graph neural network (GNN) trained to process network topology information and approximate optimal network topologies;
an adaptive peer capacity detection mechanism; and
an optimizer service configured to use an output of the RL framework to generate actions for modifying connections between peers based on current network state observations applying the actions to the P2P network to optimize the network topology.
